(19) United States
(12) Patent Application Publication
(10) Pub. No.: US 2019/0290518 A1
(43) Pub. Date: Sep. 26, 2019

(54) BED MOBILITY ASSISTANCE DEVICE AND METHOD

(71) Applicant: Sharon Hatcher, Duncan, OK (US)

(72) Inventor: Sharon Hatcher, Duncan, OK (US)

(21) Appl. No.: 16/359,553

(22) Filed: Mar. 20, 2019

Related U.S. Application Data
(60) Provisional application No. 62/645,783, filed on Mar. 20, 2018.

(51) Int. Cl. A61G 7/053

(52) U.S. Cl. CPC A61G 7/0536; A61G 7/104

(57) ABSTRACT

A bed mobility assistance device is disclosed herein. The bed mobility assistance device includes a circumferential hand grip configured to be graspable by the user, the circumferential hand grip including an elongated flexible strap having a frictional outer surface, a length sufficient to encircle a bed mattress, a two-part buckle configured to form a closed loop portion within the elongated flexible strap, the closed loop portion arrangeable circumferentially about the bed mattress, and a cinch configured to cinch the closed loop portion about the bed mattress to place the frictional outer surface of the elongated flexible strap in positions of contact with a top surface, a bottom surface, and a perimeter wall of the bed mattress. The bed mobility assistance device is useful for assisting a user self-adjust their body position on the bed mattress.

### CROSS-REFERENCE TO RELATED APPLICATION(S)

The present application is related to and claims priority to U.S. Provisional Patent Application No. 62/645,783 filed 20 Mar. 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of human mobility assistance of existing art and more specifically relates to self-help support, grip or handhold for a bed.

### RELATED ART

People with limited mobility or those recovering from injuries or surgeries may have trouble rolling over, repositioning themselves, or even sitting up in bed to bathe or change clothes. Unfortunately, lying in the same position for too long can cause pain, stiffness, pressure sores, and muscle atrophy. Therefore, some people may require help from a caregiver or family member to reposition or roll over, but this can place an enormous amount of strain and stress on these individuals. A suitable solution is desired.

Prior attempts have been made to address the above-noted problems. For example, U.S. Pat. No. 2,843,858 to Berma relates to a lift strap and exerciser for recumbent persons. The described lift strap and exerciser for recumbent persons includes an apparatus for aiding recumbent persons. One object of the invention is to provide a device for attachment to the foot of a bed, which can be used by a recumbent person to raise himself to a sitting position. Unfortunately, the usefulness of the Berma apparatus is limited in that the apparatus requires specific bed-frame arrangements for attachment. Furthermore, the physical configuration of the Berma apparatus prevents the device from remaining in a usable position without interfering with user's customary bed use.

### SUMMARY OF THE INVENTION

In view of the foregoing disadvantages inherent in the known self-help support, grip or handhold bed art, the present disclosure provides a novel bed mobility assistance device and method. The general purpose of the present disclosure, which will be described subsequently in greater detail, is to provide a bed mobility assistance device and method.

A mobility assistance device is disclosed herein. The mobility assistance device includes a circumferential hand grip configured to be graspable by the user, the circumferential hand grip including an elongated flexible strap having a frictional outer surface, a first end, a second end, and a length sufficient to encircle a bed mattress, a two-part buckle configured to form a closed loop portion within the elongated flexible strap, the closed loop portion arrangeable circumferentially about the bed mattress, the two-part buckle including a first buckle portion and a second buckle portion releasably-engageable with the first buckle portion, the first buckle portion connected to the first end, the second buckle portion adjustably engaged on the elongated flexible strap at a point intermediate to the first end and the second end, and a cinch configured to cinch the closed loop portion about the bed mattress to place the frictional outer surface of the elongated flexible strap in positions of contact with a top surface, a bottom surface, and a perimeter wall of the bed mattress.

According to another embodiment, a method of mounting a continuous circumferential hand grip on a bed mattress to assist a user self-adjust their body position on the bed mattress is also disclosed herein. The method includes selecting a continuous circumferential hand grip comprising an elongated flexible strap having a length sufficient to encircle the bed mattress; positioning the elongated flexible strap adjacent a top surface, a bottom surface, and a perimeter wall of the bed mattress; forming a closed loop portion within the elongated flexible strap, the closed loop portion encircling the bed mattress; and cinching the closed loop portion to place the elongated flexible strap in frictional contact with the top surface, the bottom surface, and the perimeter wall of the bed mattress.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a bed mobility assistance device and method, constructed and operative according to the teachings of the present disclosure.

FIG. 1 is a top view of the bed mobility assistance device during an ‘in-use’ condition, according to an embodiment of the disclosure.

FIG. 2 is a top view of the bed mobility assistance device of FIG. 1, illustrating a user after self-adjusting their body position on the bed mattress using the bed mobility assistance device, according to an embodiment of the present disclosure.

FIG. 3 is a perspective view of the bed mobility assistance device of FIG. 1, according to an embodiment of the present disclosure.

FIG. 4 is an enlarged detail view of FIG. 3, illustrating arrangements of the bed mobility assistance device of FIG. 1, according to an embodiment of the present disclosure.

FIG. 5 is a perspective view showing the bed mobility assistance device of FIG. 1 encircling the bed mattress, according to an embodiment of the present disclosure.

FIG. 6 is a perspective view showing the bed mobility assistance device of FIG. 1 in a cinched arrangement about the bed mattress, according to an embodiment of the present disclosure.

FIG. 7 is a perspective view showing the bed mobility assistance device of FIG. 1 arranged as a kit, according to an embodiment of the present disclosure.

FIG. 8 is a flow diagram illustrating a method of mounting the bed mobility assistance device of FIG. 1 to the bed mattress to provide a continuous circumferential hand grip useable by a user to self-adjust their body position on the bed mattress, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a self-help support, grip or handhold for a bed and more particularly to a bed mobility assistance device and method, including a continuous circumferential hand grip attached to a bed mattress, as used to improve an individual's ability to self-adjust their body position while resting on the bed.

Generally, the present disclosure allows people with limited mobility to turn over, reposition themselves, pull themselves up in bed, or hold themselves over on their side while being dressed, bathed, or changed. It prevents soreness and stiffness from lying in a single position. Further, it minimizes the need for help from caregivers or family members, encouraging independence and self-reliance. The device reduces strain and stress on caregivers and family members, as well as injuries to individuals using the belt. The present invention accommodates a wide range of people, including those recovering from a stroke, Parkinson's disease, back or hip surgery, multiple sclerosis, obesity, post-polio, generalized weakness, 3rd trimester pregnancy, and amputations.

The device is useful in helping people move and reposition themselves in bed for maximum comfort and convenience for both patients and caregivers. This device may include a belt, made from a long piece of two-inch wide flat nylon webbing, or other suitable material, which can be cut to various lengths, depending on the size of bed it will surround. The length of the belt is generally equal to twice the width of a bed, taking into account the top and bottom of a mattress, plus twice the depth of a mattress, taking into account both sides. A quick-release buckle may be joined to an end of the belt; the corresponding half of the buckle has webbing that can be looped through slots, allowing for adjustments as needed.

In use, the belt is wrapped completely around a mattress, over the fitted sheet, and secured with the buckle. The adjustable end is pulled tight to prevent belt from moving when the user pulls on the device. The device may be provided with a greater length to extend vertically instead of horizontally. The exact specifications may vary upon manufacturing.

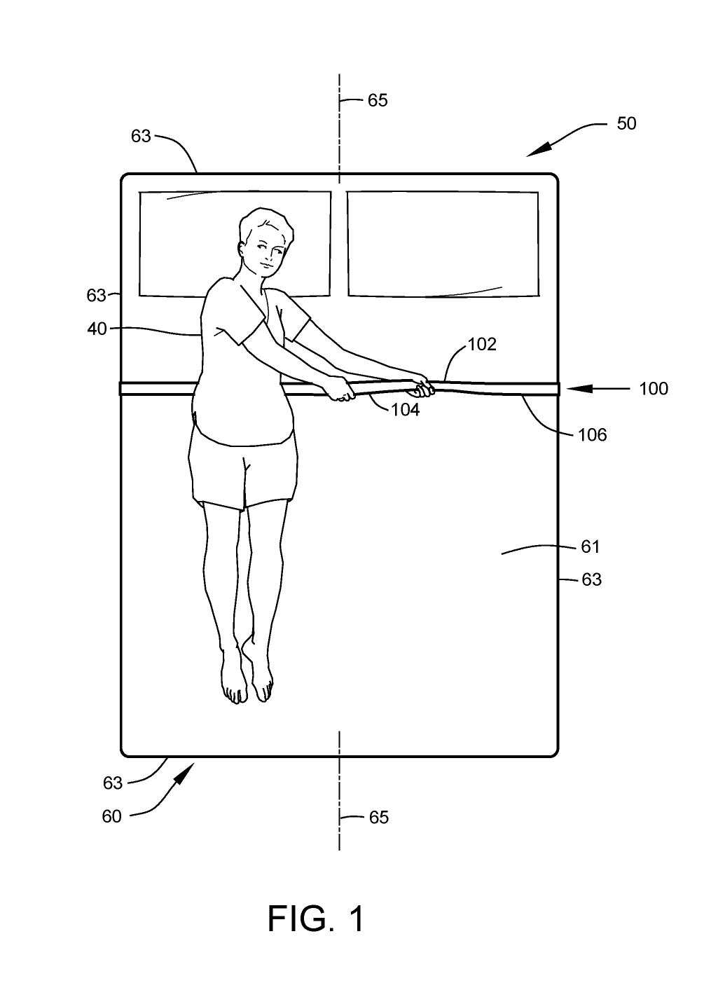

Referring now more specifically to the drawings by numerals of reference, there is shown in FIGS. 1-7, various views of a bed mobility assistance device 100.

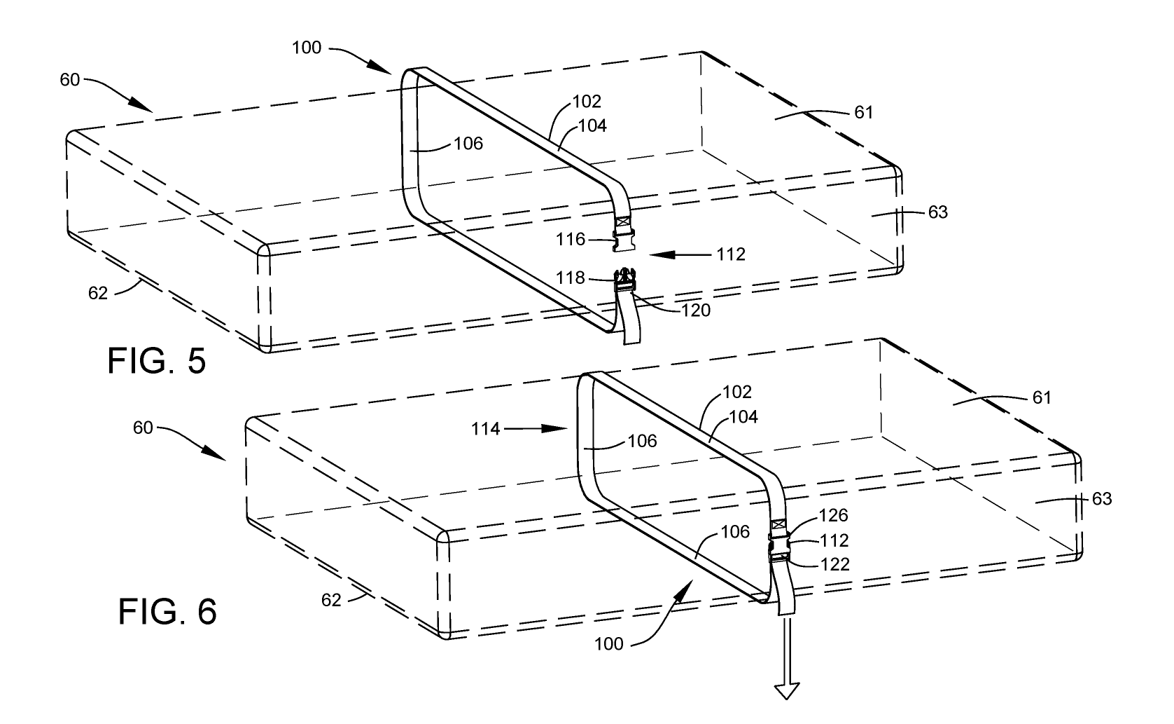

FIG. 1 shows a bed mobility assistance device during an ‘in-use’ condition 50, according to an embodiment of the present disclosure. Here, the bed mobility assistance device may be beneficial for use by a user 40 to self-adjust their body position while resting on a bed mattress 60. As illustrated, the bed mobility assistance device 100 may include a circumferential hand grip 102 graspable by the user 40. The hand grip 102 may include an elongated flexible strap 104 having a frictional outer surface 106. In use, the belt is wrapped completely around the bed mattress 60, over the fitted sheet, and removably-secured at the side (see FIG. 5 and FIG. 6). As illustrated in FIG. 1, the graspable hand grip 102 may extend continuously across a top surface 61 of the bed mattress 60, thus maintaining access to the device, regardless of the user's position on the bed. When installed, a user 40 may use the hand grip 102 to reposition themselves on the bed, without the assistance of another individual.

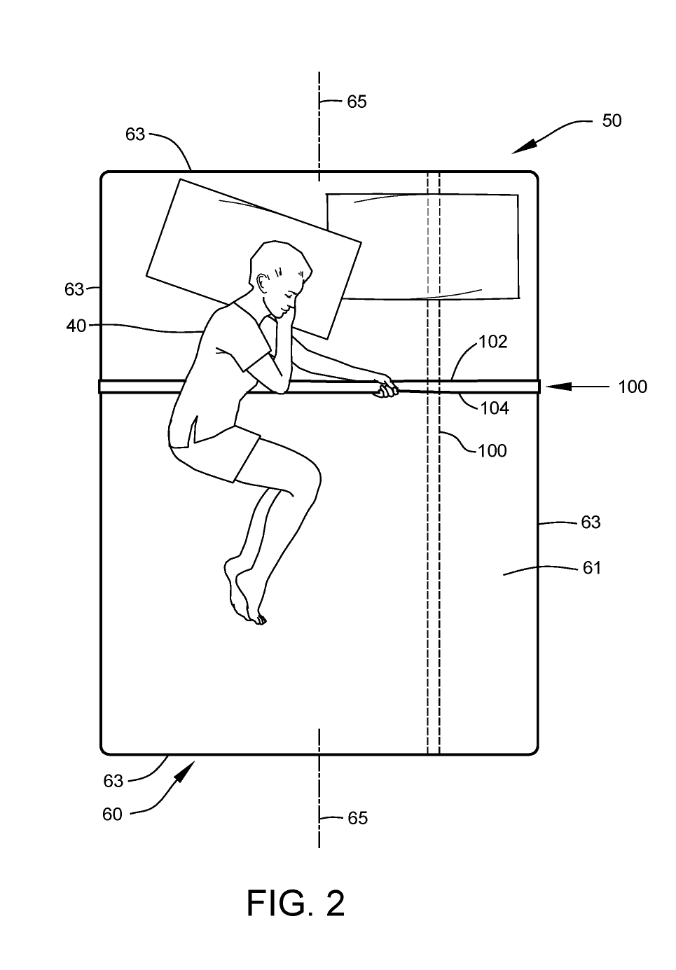

In one arrangement of the present disclosure, the elongated flexible strap 104 of the bed mobility assistance device 100 may be mounted in a side-to-side orientation substantially perpendicular to a longitudinal axis 65 of the bed mattress 60, as shown. Alternately, the elongated flexible strap 104 of the bed mobility assistance device 100 may be mounted in a head-to-foot orientation substantially parallel to the longitudinal axis 65 of the bed mattress 60, as illustrated by the dashed-line depiction of FIG. 2.

FIG. 2 is a top view of the bed mobility assistance device 100 of FIG. 1, illustrating the user 40 in a new resting position after using the bed mobility assistance device 100 to self-adjust their body position on the bed mattress 60, according to an embodiment of the present disclosure. The dashed-line depiction of FIG. 2 illustrates the elongated flexible strap 104 of the bed mobility assistance device 100 mounted in the alternate orientation that is substantially parallel to the longitudinal axis 65 of the bed mattress 60. It should be noted that bed mobility assistance device 100 may be mounted to pass over the top surface 61 of the bed mattress 60 any user-selected position. Upon reading this specification, it should be appreciated that, under appropriate circumstances, considering such issues as user preferences, design preference, structural requirements, marketing preferences, cost, available materials, etc., other mounting arrangements such as, for example, installing multiple devices on the same mattress in parallel orientations, installing multiple devices in the both transverse and parallel orientations, etc., may be sufficient.

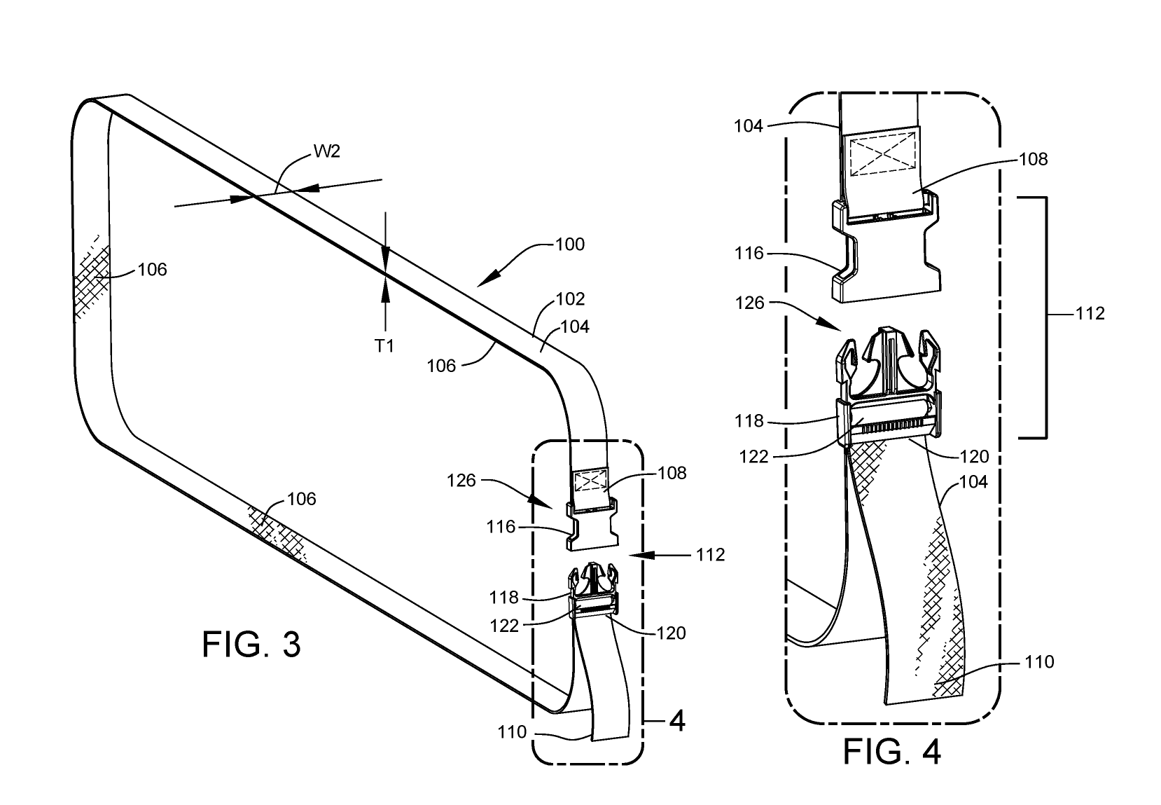

FIG. 3 is a perspective view of the bed mobility assistance device 100 of FIG. 1, according to an embodiment of the present disclosure. FIG. 4 is the enlarged detail view 4 of FIG. 3, further illustrating arrangements of the bed mobility assistance device 100 of FIG. 1, according to an embodiment of the present disclosure. FIG. 5 is a perspective view showing the bed mobility assistance device 100 of FIG. 1 encircling the bed mattress 60, according to an embodiment of the present disclosure. The circumferential hand grip 102 of the bed mobility assistance device 100 may consisting of an elongated flexible strap 104 having a first end 108, a second end 110, and an end-to-end length sufficient to encircle the bed mattress 60 (see also FIG. 5). The elongated flexible strap 104 may be formed as a single segment having a width W1 of about two inches and a thickness T1 of less than about ¼ inch. In a preferred arrangement of the present disclosure, the elongated flexible strap 104 has a thickness T1 of about 0.1 inch. By utilizing a material that is both flexible and flat, the elongated flexible strap 104 may extend over the top of the bed mattress and pass under the body of user without discomfort to the user 40, thus allowing full use of the bed surface while remaining in close reach.

The elongated flexible strap 104 may be constructed of a woven material. More specifically, the elongated flexible strap 104 may be constructed of a single segment of flat woven webbing. The elongated flexible strap 104 may include a frictional surface to inhibit slippage when installed on the bed mattress 60. In one arrangement of the present disclosure, the frictional outer surface 106 of the elongated flexible strap 104 may be provided by the woven texture of the flat woven webbing, as shown.

The elongated flexible strap 104 may be formed using a durable and cleanable fiber suitable for prolonged contact with the skin. The elongated flexible strap 104 may be formed from a natural fiber, a synthetic fiber, or a combined blend of natural and synthetic fibers. In one arrangement of the present disclosure, the elongated flexible strap 104 is constructed of nylon. In one arrangement of the present disclosure, a resilient polymer of the strap material may be used as the frictional outer surface 106. Upon reading this specification, it should be appreciated that, under appropriate circumstances, considering such issues as user preferences, design preference, cost, available materials, technological advances, etc., other strap arrangements such as, for example, including additional hand loops, adding hook-and-loop elements to support and retain oxygen lines/monitor wires, embedding monitors/sensors within the strap, including photo-luminescent elements to assist location in a darkened room, providing sections of padding, adding loops for the attachment of accessory devices, etc., may be sufficient.

The elongated flexible strap 104 may include a quick-release two-part buckle 112 used to form a closed loop portion 114 within the elongated flexible strap 104. The closed loop portion 114 may be wrapped about the bed mattress 60, circumferentially, as shown in FIG. 5. The two-part buckle 112 may include a first buckle portion 116 and a second buckle portion 118, as shown. The second buckle portion 118 may be of a type that is releasably-engageable with the first buckle portion 116 using, for example, a quick-release “snap-lock” connection. In one arrangement of the present disclosure, the two-part buckle 112 may be a side-release-type buckle 126 having interconnecting male and female members. The male member of the buckle may include a pair of resilient arms that may be inserted and releasably locked in the female member to couple the members. Each arm may include an abutment surface that is releasably engageable with a corresponding retaining surface in the female member. Such side-release buckles may include recesses at the sides of the female member that expose the arms of the male member such that the male and female members may be uncoupled by pressing the arms of the male member at the side recesses to disengage the abutment and retaining surfaces. In the present disclosure, the first buckle portion 116 is a female member and the second buckle portion 118 is a male member; however, the gender of the buckle portions may be interchanged without diminishing the functionality of the device.

As illustrated, the first buckle portion 116 may be connected to the first end 108 of the elongated flexible strap 104, as shown. The second buckle portion 118 may be adjustably engaged on the elongated flexible strap 104 at a point 120 that is intermediate to (i.e., located between) the first end 108 and the second end 110, as shown. The device may further include a cinch 122 to cinch (i.e., tighten) the closed loop portion 114 of the strap about the bed mattress 60, as shown in FIG. 6.

FIG. 6 is a perspective view showing the bed mobility assistance device 100 of FIG. 1 in a cinched arrangement about the bed mattress 60, according to an embodiment of the present disclosure. An installer of the device may use the cinch 122 to tighten the closed loop portion 114 around the bed mattress 60 until the frictional outer surface 106 of the elongated flexible strap 104 is in contact with the top surface 61, the bottom surface 62, and the perimeter wall 63 of the bed mattress 60. In this secured arrangement, the user 40 may apply a significant pulling force on the hand grip 102 without significant slippage of the bed mobility assistance device 100 relative to the bed mattress 60.

In one arrangement of the present disclosure, the cinch 122 may be integrally formed within the two-part buckle 112. In this arrangement, the cinch 122 may be integrally formed within either the first buckle portion 116 or the second buckle portion 118. In the present disclosure, the cinch 122 is integrated within second buckle portion 118, as shown. Upon reading this specification, it should be appreciated that, under appropriate circumstances, considering such issues as user preferences, design preference, structural requirements, marketing preferences, cost, available materials, technological advances, etc., other cinching arrangements such as, for example, including a cinching feature in both buckle portions, providing a separate cinching device, including an elastic segment within the strap, etc., may be sufficient.

As noted above, the elongated flexible strap 104 may have an end-to-end length at least sufficient to encircle the bed mattress 60. The length of the elongated flexible strap 104 is generally based on the size of the bed mattress on which the device is installed. Strap lengths are generally based on standard mattress sizes, which vary from country to country. In North America, the most common mattress sizes are twin or single, twin XL, full or double, queen, and king. The size of these mattresses range between about 38 inches and about 72 inches in width and about 75 inches and about 84 inches in length. In general, the length of the elongated flexible strap 104 is determined by adding together the width (or length) of the top surface 61 and the bottom surface 62 of the bed mattress 60 and double the height of the perimeter wall 63. An additional foot (12″) of strap material may be added to the strap length to allow for cinching and variability of mattress thicknesses. Thus, the elongated flexible strap 104 of the bed mobility assistance device 100 may be supplied in varying lengths, generally ranging between about ten and about eighteen feet.

In some embodiments of the present disclosure, bed mobility assistance device 100 may be pre-installed at the factory by the manufacturer of the bed mattress 60, by the manufacturer of the bed mobility assistance device 100, or by other manufacturing entities. In this arrangement, the bed mobility assistance device 100 may include the bed mattress 60.

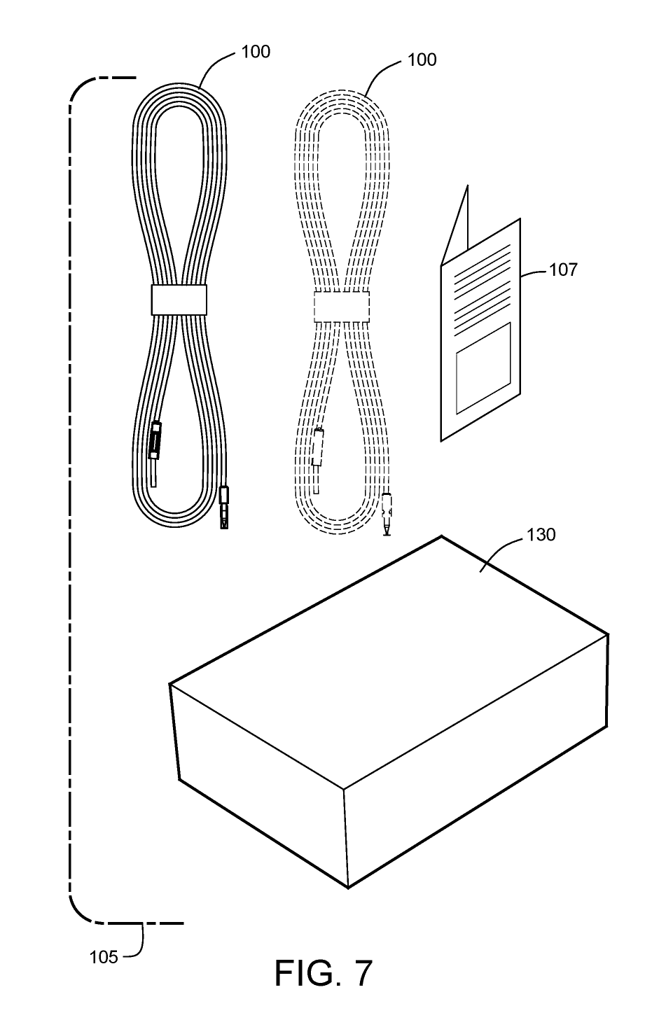

FIG. 7 is a perspective view showing the bed mobility assistance device 100 of FIG. 1 arranged as a kit 105, according to an embodiment of the present disclosure. In particular, the bed mobility assistance device 100 may further include a set of instructions 107. The instructions 107 may detail functional relationships in relation to the structure of the bed mobility assistance device 100 such that the bed mobility assistance device 100 can be used, maintained, or the like, in a preferred manner. Further, it provides such a bed mobility assistance device 100, wherein the kit 105 further comprises at least two circumferential hand grips 102, each circumferential hand grip 102 having an elongated flexible strap 104 of the same or of differing lengths. Even further, the kit 105 may include product packaging 130 configured to package the above-noted components of the kit 105. Upon reading this specification, it should be appreciated that, under appropriate circumstances, considering such issues as user preferences, design preference, cost, available materials, technological advances, etc., other kit arrangements such as, for example, including additional straps, providing attachable accessory devices, including instructions in form of digital media, providing the device in multiple colors/patterns to match the bedding, including a bed mattress, etc., may be sufficient.

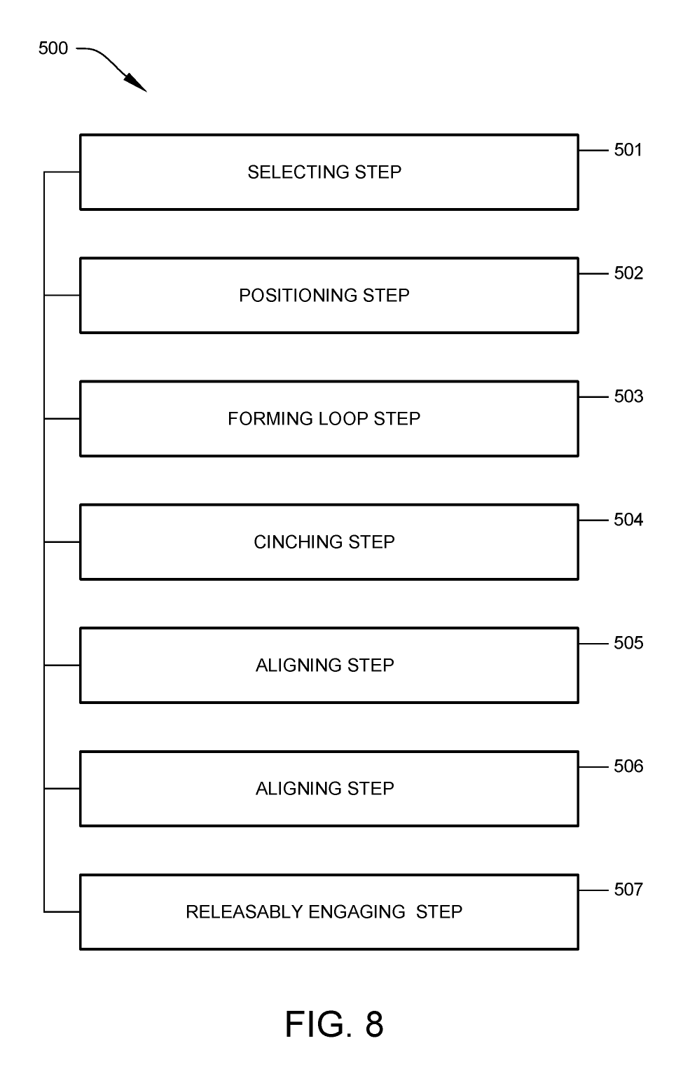

FIG. 8 is a flow diagram illustrating a method 500 of mounting a continuous circumferential hand grip 102 on a bed mattress 60 to assist a user 40 self-adjust their body position on the bed mattress 60, according to an embodiment of the present disclosure. In particular, the method 500 may include one or more components or features of the bed mobility assistance device 100 as described above. As illustrated, the method 500 may include the steps of: step one 501, selecting a continuous circumferential hand grip 102 comprising an elongated flexible strap 104 having a length sufficient to encircle the bed mattress 60; step two 502, positioning the elongated flexible strap 104 adjacent a top surface 61, a bottom surface 62, and a perimeter wall 63 of the bed mattress 60; step three 503, forming a closed loop portion 114 within the elongated flexible strap 104, the closed loop portion 114 encircling the bed mattress 60; and step four 504, cinching the closed loop portion 114 to place the elongated flexible strap 104 in frictional contact with the top surface 61, the bottom surface 62, and the perimeter wall 63 of the bed mattress 60. Method 500 may further include the step five 505, of aligning the elongated flexible strap 104 in an orientation substantially perpendicular to a longitudinal axis of the bed mattress 60. Moreover, method 500 may further include the alternate step 506 of aligning the elongated flexible strap 104 in an orientation substantially parallel to a longitudinal axis of the bed mattress 60. Even further, the step 503 of forming a closed loop portion 114 within the elongated flexible strap 104 may further comprises the step seven 507, of forming the closed loop portion 114 by releasably engaging a first buckle portion 116 and a second buckle portion 118 of a two-part buckle 112 engaged on the elongated flexible strap 104.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of mounting a continuous circumferential hand grip on a bed mattress to assist a user self-adjust their body position on the bed mattress, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1) A mobility-assistance device for assisting a user self-adjust their body position on a bed mattress, the bed mattress having a top surface, a bottom surface, and a perimeter wall extending between the top surface and the bottom surface, the mobility-assistance device comprising:
a circumferential hand grip configured to be graspable by the user, the circumferential hand grip including
an elongated flexible strap having a frictional outer surface, a first end, a second end, and a length sufficient to encircle the bed mattress,
a two-part buckle configured to form a closed loop portion within the elongated flexible strap, the closed loop portion arrangeable circumferentially about the bed mattress, the two-part buckle including a first buckle portion and a second buckle portion releasably-engageable with the first buckle portion, the first buckle portion connected to the first end, the second buckle portion adjustably engaged on the elongated flexible strap at a point intermediate to the first end and the second end, and
a cinch configured to cinch the closed loop portion about the bed mattress to place the frictional outer surface of the elongated flexible strap in positions of contact with the top surface, the bottom surface, and the perimeter wall of the bed mattress.

2) The mobility-assistance device of claim 1 wherein the width of the elongated flexible strap is about two inches.

3) The mobility-assistance device of claim 1 wherein the thickness of the elongated flexible strap is less than about ¼ inch.

4) The mobility-assistance device of claim 1 wherein the length of the elongated flexible strap is between about ten and about eighteen feet.

5) The mobility-assistance device of claim 1 wherein the elongated flexible strap is constructed of a woven material.

6) The mobility-assistance device of claim 1 wherein the elongated flexible strap is constructed of flat woven webbing.

7) The mobility-assistance device of claim 1 wherein the frictional outer surface of the elongated flexible strap consists of a woven texture.

8) The mobility-assistance device of claim 1 wherein the elongated flexible strap is constructed of at least one natural fiber.

9) The mobility-assistance device of claim 1 wherein the frictional outer surface of the elongated flexible strap consists of a resilient polymer.

10) The mobility-assistance device of claim 1 wherein the elongated flexible strap is constructed of nylon.

11) The mobility-assistance device of claim 1 wherein
the two-part buckle consists of a side-release-type buckle; and
the cinch is integrally formed within at least one of the first buckle portion and the second buckle portion.

12) The mobility-assistance device of claim 1 further comprising the bed mattress.

13) A mobility-assistance device for assisting a user self-adjust their body position on a bed, comprising:
a bed mattress having a top surface, a bottom surface, and a perimeter wall extending between the top surface and the bottom surface;
a circumferential hand grip configured to be graspable by the user, the circumferential hand grip including
an elongated flexible strap having a frictional outer surface, a first end, a second end, and a length sufficient to encircle bed mattress,
a two-part buckle configured to form a closed loop portion within the elongated flexible strap, the closed loop portion arrangeable circumferentially about the bed mattress, the two-part buckle including a first buckle portion and a second buckle portion releasably-engageable with the first buckle portion, the first buckle portion connected to the first end, the second buckle portion adjustably engaged on the elongated flexible strap at a point intermediate to the first end and the second end;
a cinch configured to cinch the closed loop portion about the bed mattress to arrange the frictional outer surface of the elongated flexible strap in positions of contact with the top surface, the bottom surface, and the perimeter wall of the bed mattress;
wherein the thickness of the elongated flexible strap is less than about ¼ inch;
wherein the width of the elongated flexible strap is about two inches;
wherein the elongated flexible strap is constructed of a woven material;
wherein the frictional outer surface of the elongated flexible strap consists of a woven texture;
wherein the elongated flexible strap is constructed of at least one of a natural fiber and a synthetic fiber;
wherein the two-part buckle comprises a side-release-type buckle; and
wherein the cinch is integrally formed within the two-part buckle.

14) The mobility-assistance device of claim 13, further comprising set of instructions; and wherein the mobility-assistance device is arranged as a kit.

15) The mobility-assistance device of claim 14, wherein the kit further comprises at least two circumferential hand grips.

16) The mobility-assistance device of claim 15, wherein the kit further comprises product packaging adapted to package the kit.

17) A method of mounting a continuous circumferential hand grip on a bed mattress to assist a user self-adjust their body position on the bed mattress, comprising the steps of:
selecting a continuous circumferential hand grip comprising an elongated flexible strap having a length sufficient to encircle the bed mattress;
positioning the elongated flexible strap adjacent a top surface, a bottom surface, and a perimeter wall of the bed mattress;
forming a closed loop portion within the elongated flexible strap, the closed loop portion encircling the bed mattress; and
cinching the closed loop portion to place the elongated flexible strap in frictional contact with the top surface, the bottom surface, and the perimeter wall of the bed mattress.

18) The method of claim 17 further comprising the step of aligning the elongated flexible strap in an orientation substantially perpendicular to a longitudinal axis of the bed mattress.

19) The method of claim 17 further comprising the step of aligning the elongated flexible strap in an orientation substantially parallel to a longitudinal axis of the bed mattress.

20) The method of claim 17 wherein the step of forming a closed loop portion within the elongated flexible strap further comprises the step of forming the closed loop portion by releasably engaging a first buckle portion and a second buckle portion of a two-part buckle engaged on the elongated flexible strap.
